(19) United States
(12) Patent Application Publication
(10) Pub. No.: US 2006/0184685 A1
(43) Pub. Date: Aug. 17, 2006

(54) System for distribution of numerous streams of multimedia content to a multiplicity of video displays

(75) Inventor: Steve Blasingame, Thousand Oaks, CA (US)

Correspondence Address: KLEINBERG & LERNER, LLP, 2049 CENTURY PARK EAST, SUITE 1080, LOS ANGELES, CA, 90067, US

(73) Assignee: LANTASM NETWORKS, INC.

(21) Appl. No.: 11/355,826

(22) Filed: Feb. 15, 2006

Related U.S. Application Data
(60) Provisional application No. 60/653,922, filed on Feb. 17, 2005.

(51) Int. Cl. G06F 15/16

(52) U.S. Cl. 709/231

(57) ABSTRACT

Each of a plurality of remotely located video displays, projectors or multimedia equipment receives operator scheduled and initiated streams of multimedia content. Under the control of the operator each remotely located video display may receive from one to many multimedia streams. Each remotely located video display is associated with a multimedia distribution switch node. Multimedia distribution switch nodes may be configured as feature modules integrated into video displays, optional slot-cards specific to particular varieties of video displays or as stand-alone devices. Multimedia distribution switch nodes are capable of sustaining at least two physical connections to either a copper interface 1000 megabit per second (or greater) network or a fiber-optic 1000 megabit per second (or greater) network.

### CLAIM OF PRIORITY

This application claims priority based on provisional application No. 60/653,922 filed Feb. 17, 2005 and entitled “System for distribution of numerous streams of multimedia content to a multiplicity of video displays.”

### BACKGROUND OF INVENTION

1. Field of the Invention

The present invention relates to distribution of multimedia video and audio content over a multi-node Gigabit Ethernet network for applications including but not limited to digital signage, information displays, front or rear screen video projection, and digital cinema. The invention employs a multicast approach, embedding the switching of multimedia streams in the network. This eliminates requirements for audio/video encoder/transmitters, distribution amplifiers, audio/video matrix switches and most cabling. Individual multimedia distribution switch (MDS) nodes provide a hierarchical network topology, minimizing cable requirements and eliminating most requirements for fiber optic cable installation. This approach reduces overall installed system costs by as much as one half over current approaches.

2. Description of the Related Art

Current CAT-5 commercial video/audio distribution systems employed for digital signage, information displays, front or rear screen video projection, and digital cinema employ analog encoding technology to transmit a single unicast baseband video/audio signal to one or more receivers. An encoder/transmitter and a cable is typically required for each receiver and destination video display. A single transmitted video/audio signal is distributed to multiple CAT-5 cables by means of a video/audio distribution amplifier (DA). Multiple video/audio signals may be transmitted by multiple encoder/transmitters to multiple decoder/receivers. However, to enable switching of video signals among multiple encoder/transmitters and multiple decoder/receivers, a video/audio matrix switch is required. This approach incurs substantial incremental costs due to the required cabling for each receiver, a frequent requirement for distribution amplifiers and video/audio matrix switches.

Current fiber optic commercial video/audio distribution systems employed for digital signage, information displays, front or rear screen video projection, and digital cinema employ either analog or digital encoding technology to transmit a single unicast baseband video/audio signal to one or more receivers. An encoder/transmitter and a single cable is typically required for each receiver and destination video display. A single transmitted video/audio signal is distributed to multiple fiber optic encoder/transmitters and fiber optic cables by means of a video/audio distribution amplifier (DA). Multiple video/audio signals may be transmitted by multiple fiber optic encoder/transmitters to multiple fiber optic decoder/receivers. However, to enable switching of video signals among multiple fiber optic encoder/transmitters and multiple fiber optic decoder/receivers, a video/audio matrix switch is required. Most matrix switches accept only baseband video and audio signals. This approach incurs substantial incremental costs due to the required cabling for each receiver, a requirement for distribution amplifiers and video/audio matrix switches. Furthermore, because of the digital encoding of baseband video and audio signals, fiber optic systems incur greater incremental cost than CAT-5 baseband video distribution systems due to the requirement of broadband electro-optic transmitters. Such interfaces can account for up to 50 percent of the material cost of fiber optic transmission systems.

It is therefore an object of the present invention to provide multi-media content to any number of displays, via any number of multimedia distribution nodes, utilizing one or more Gigabit Ethernet switches for substantially reduced cost of deployment and of maintenance than methods of the prior art. It is an additional object of the present invention to provide a streamlined means of providing multimedia content to numerous displays, simultaneously, without the requirement of individual cabling from each of the video servers and baseband audio/video sources to the displays, that are required in prior art inventions. This and other objects of the present invention will be seen in the following figures and detailed description of the invention.

### BRIEF DESCRIPTION OF THE DRAWINGS

FIG. 1 is a block diagram of an embodiment of a system for distribution of streaming multicast multimedia content (principally encoded video and audio) consisting of a plurality video servers and video encoders, a Gigabit Ethernet switch, a CAT-5, CAT5e or CAT-6 twisted pair distribution medium or a fiber optic distribution medium and a plurality of MDS nodes with accompanying large screen video displays. The Gigabit Ethernet switch shall support a plurality of IEEE 802.3u compliant 100BASE-T ports, one or more multimedia distribution ports consisting of one of: IEEE 802.3ab compliant 1000BASE-T or ANSI/TIA 854 compliant 10/100/1000BASE-TX or IEEE 802.3z compliant 100BASE-SX, 1000BASE-LX, or 1000BASE-LH or IEEE 802.3ah compliant 1000BASE-PX fiber optic physical interface.

FIG. 2 is a block diagram of the network topology of a system for distribution of streaming multicast multimedia content (principally encoded video and audio) consisting of a Gigabit Ethernet downlink, a CAT-5, CAT-5e or CAT-6 twisted pair distribution medium or a fiber optic distribution medium and a plurality of MDS nodes with accompanying large screen video displays. A plurality of multimedia content streams is depicted terminated on the MDS nodes serving different large screen video displays. The aforementioned Gigabit Ethernet downlink may consist of one of: IEEE 802.3ab compliant 1000BASE-T or ANSI/TIA 854 compliant 10/100/1000BASE-TX or IEEE 802.3z compliant 1000BASE-SX, 1000BASE-LX, or 1000BASE-LH or IEEE 802.3ah compliant 1000BASE-PX fiber optic physical interface.

FIG. 3 is a block diagram depicting the functional elements, buses and data paths of an MDS node. The diagram depicts an example integrated video processor supporting input of compressed and encoded video and output of baseband video. The diagram also depicts an example integrated Gigabit Ethernet processor, which includes support for Gigabit Ethernet Media Access Control (MAC) and Copper Physical Interfaces (PHY). A different integrated Gigabit Ethernet processor than the one depicted may be selected and may include other copper or fiber optic physical interfaces consisting of one of: IEEE 802.3ab compliant 1000BASE-T or ANSI/TIA 854 compliant 10/100/1000BASE-TX or IEEE 802.3z compliant 1000BASE-SX, 1000BASE-LX, or 1000BASE-LH or IEEE 802.3ah compliant 1000BASE-PX fiber optic physical interface.

### DETAILED DESCRIPTION OF THE PREFERRED EMBODIMENTS

Disclosed herein are methods and systems that facilitate distribution of multimedia video and audio content over a multi-node Gigabit Ethernet network employing a multicast approach, embedding the switching of multimedia streams in the network. The approach is suitable for applications including but not limited to digital signage, information displays, front or rear screen video projection, and digital cinema. This invention eliminates requirements for audio/video encoder/transmitters, distribution amplifiers, audio/video matrix switches and most cabling. Individual network nodes provide a hierarchical network topology, minimizing cable requirements and eliminating most requirements for fiber optic cable installation. This approach reduces overall installed system costs by as much as one half over current approaches.

For the purposes of this patent application, the term “video” may be construed as being inclusive of both video with accompanying audio and video without accompanying audio. Further, the term “multimedia content” may be construed as being inclusive of audio without accompanying video, video without accompanying audio, and video with accompanying audio.

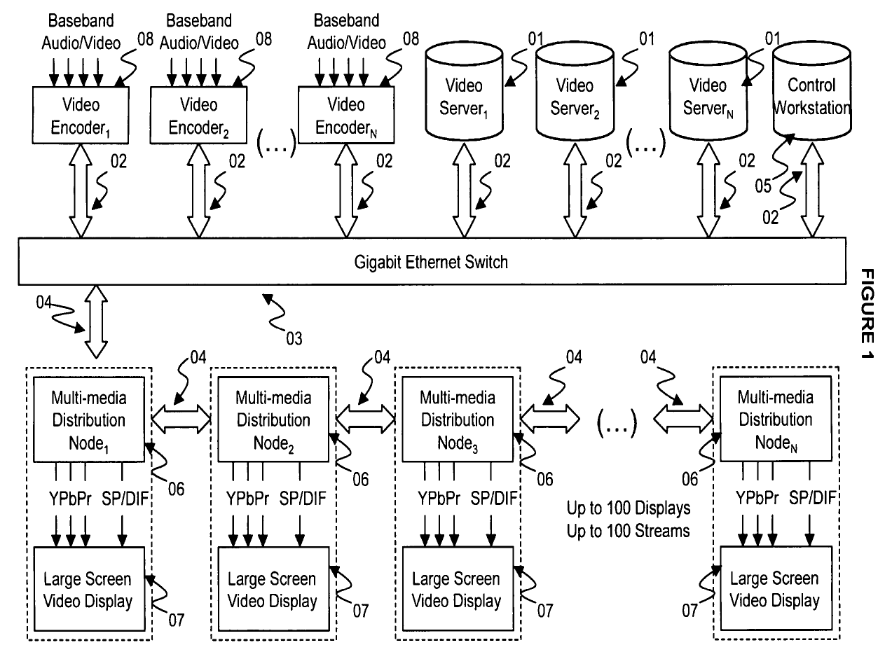

FIG. 1 is a block diagram of an embodiment of a system for distribution of streaming multicast multimedia content (principally encoded video and audio) consisting of a plurality video servers 01, and video encoders, 08, a control workstation, 05, consisting of a PC, a Gigabit Ethernet switch 03, a CAT-5, CAT5e or CAT-6 twisted pair distribution medium or a fiber optic distribution medium, 02 or 04, and a plurality of MDS nodes, 06 with accompanying large screen video displays, 07. The Gigabit Ethernet switch shall support a plurality of IEEE 802.3u compliant 100BASE-T ports, 02, one or more multimedia distribution ports, 04, consisting of one of: IEEE 802.3ab compliant 1000BASE-T or ANSI/TIA 854 compliant 10/100/1000BASE-TX or IEEE 802.3z compliant 1000BASE-SX, 1000BASE-LX, or 1000BASE-LH or IEEE 802.3ah compliant 1000BASE-PX fiber optic physical interface.

The baseband audio/video encoders, 08, may be one of: transcoding devices that accept video/audio content from cable, terrestrial or satellite broadcast and encode it for IP multicast transmission; encoding devices that accept baseband video/audio. The baseband video accepted by the encoder may be at least one of: Component Video (YPbPr), RGB Video (RGsB or RGBHV), Digital Visual Interface (DVI-D), S-Video, High Definition Multimedia Interface (HDMI), Serial Digital Interface (SDI) video, High Definition Serial Digital Interface video. The baseband audio man be at least one of: stereo unbalanced analog audio (RCA Phono), Sony-Philips Digital Interface Format (SP/DIF), High Definition Multimedia Interface (HDMI), stereo balanced analog audio, AES/EBU digital audio, Multimedia Digital Audio Interface (MADI). There may be 50 to 100 encoders connected to the network switch, 03, by IEEE 802.3u compliant 100BASE-T interfaces, 02, each serving a different multimedia content stream to any of the MDS nodes, 06 and their respective video displays, 07. The encoders may also accept multimedia content from servers with the capability to generate multimedia content from online software and display it in video/audio formats compatible with the encoder.

The video servers, 01, have the capability to stream (play out) one or more multimedia content streams as IP multicast streams over IEEE 802.3u compliant 100BASE-T interfaces, 02, to the network switch, 03. The content is stored on each of the servers as files and may be under the control of scheduling software that resides both on the video servers and at remote locations.

The video servers, 01, along with the video encoders, 08, are used to store and stream or to encode and stream, respectively, multimedia content to the Gigabit Ethernet switch 03. The Gigabit Ethernet switch is then used to transmit the plurality of multimedia streams to the multi-media distribution nodes 06 and corresponding large screen displays 07. Any number of simultaneous streams of multimedia content and thus, any number of different displays, may be supported using this method, without the use of substantial extra cabling, distribution amplifiers or broadband electro-optic transmitters. This results in a substantial drop in the total cost of roll-out and use of this system over the systems of the prior art.

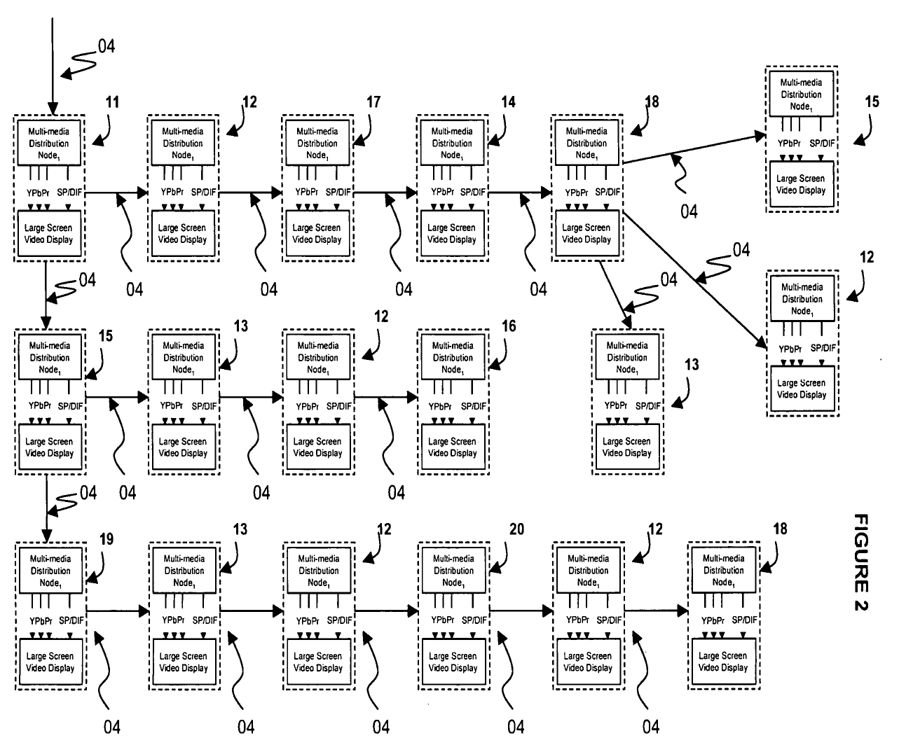

FIG. 2 is a block diagram of the network topology of a system for distribution of streaming multicast multimedia content (principally encoded video and audio) consisting of a Gigabit Ethernet network, 04, a CAT-5, CAT-5e or CAT-6 twisted pair distribution medium or a fiber optic distribution medium, 04, and a plurality of MDS nodes with accompanying large screen video displays. A series of multiple multimedia content streams, 11,12,13,14,15,16,17,18,19, and 20, are depicted as terminating on the MDS nodes serving different large screen video displays. The aforementioned Gigabit Ethernet network, 04, may consist of one of: IEEE 802.3ab compliant 1000BASE-T or ANSI/TIA 854 compliant 10/100/1000BASE-TX or IEEE 802.3z compliant 1000BASE-SX, 1000BASE-LX, or 1000BASE-LH or IEEE 802.3ah compliant 1000BASE-PX fiber optic physical interface.

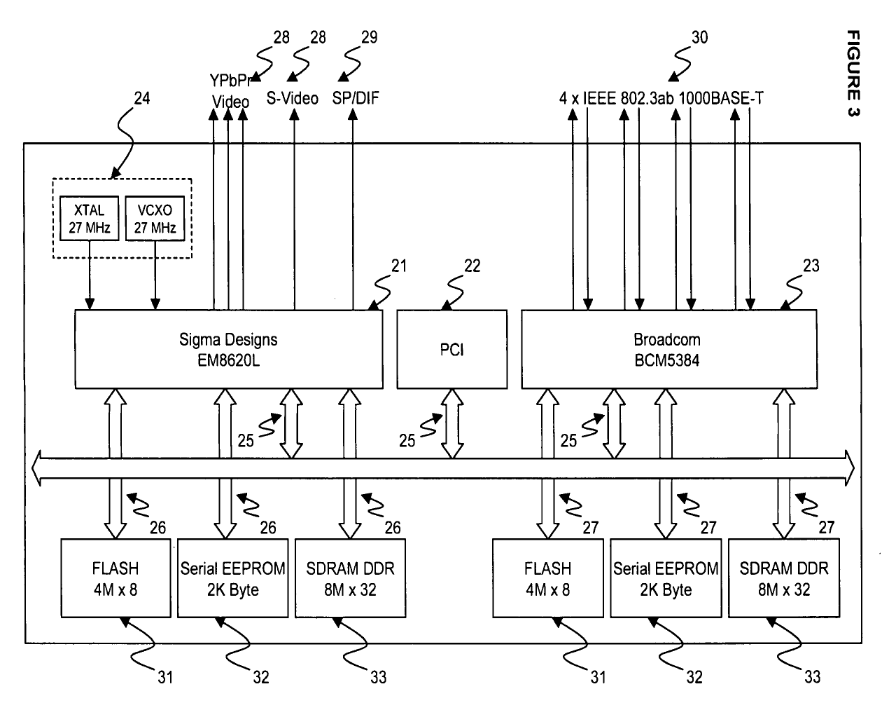

The Gigabit Ethernet network 04 is mediated by switches in each of the MDS nodes and may take on any topology within the confines specified in the standard description of the Gigabit Ethernet PHY utilized. The depicted system of the preferred embodiment utilizes an IEEE 802.3ab compliant 1000BASE-T PHY and is depicted with a hierarchical topology. The MDS nodes of the preferred embodiment are configured with 4 1000BASE-T ports (visible in FIG. 3, element 30) and may be connected to up to 3 downstream MDS nodes and a single upstream node or Gigabit Ethernet switch. In alternative embodiments, any number of downstream MDS nodes and upstream nodes or Gigabit Ethernet switches may be connected, subject to technological or bandwidth constraints. Though current architecture does not include a description for a redundant network system or a hierarchy in which an MDS node may be connected to more than one upstream MDS node or Gigabit Ethernet switch, such architecture is not precluded for the purposes of this patent application.

The Gigabit Ethernet network 04 carries any number of encoded multimedia streams, subject to bandwidth constraints based upon the type of content and alternative uses of the bandwidth (for example). The Gigabit Ethernet network 04 is a branching hierarchy such that each MDS node is capable, upon connection to the Gigabit Ethernet network 04, of receiving content, as streamed, through a prior node. A benefit of this topology is the elimination of the need for cabling, expensive fiber optic rollout to each node or other analog content enablers, such as encoders, decoders, signal amplifiers, etc. Using this system, numerous streams of content may be provided to numerous multimedia distribution nodes and their corresponding displays, along with the multimedia distribution nodes connected to the prior node.

FIG. 3 is a block diagram depicting the preferred embodiment, including the functional elements, buses and data paths of an MDS node. The diagram depicts an example integrated video processor 21 supporting input of compressed and encoded video over a PCI bus interface 25 and output of baseband video 28 and audio 29. A separate clock and crystal 24 support the integrated video processor. Flash memory 31 a serial EEPROM 32 and SDRAM 33 are attached to tie integrated video processor memory bus 26. A different integrated video processor than the one depicted may be selected and may include other interfaces. An integrated PCI bus controller 22 controls the PCI bus 25. The diagram also depicts an example integrated Gigabit Ethernet processor 23 which features onboard Gigabit Ethernet Media Access Control (MAC) and Copper Physical Interfaces (PHY). The depicted Gigabit Ethernet processor supports 4 IEEE 802.3ab compliant 1000BASE-T ports, 30. The Gigabit Ethernet processor is connected to the integrated video processor by means of a PCI bus interface 25. Flash memory 31 a serial EEPROM 32 and SDRAM 33 are attached to tie integrated Gigabit Ethernet processor memory bus 27. A different integrated Gigabit Ethernet processor than the one depicted may be selected and may include other copper or fiber optic physical interfaces consisting of one of: IEEE 802.3ab compliant 1000BASE-T or ANSI/TIA 854 compliant 10/100/1000BASE-TX or IEEE 802.3z compliant 1000BASE-SX, 1000BASE-LX, or 1000BASE-LH or IEEE 802.3ah compliant 1000BASE-PX fiber optic physical interface. The depicted MDS node is an example of the preferred embodiment. Alternative embodiments including more or fewer elements, different elements, and additional elements are also envisioned. Additional audio or video processors, additional or fewer Ethernet connections, additional or alternative audio and video outputs, alternative interfaces to the preferred PCI interface and different methods of storing data than the flash memory, EEPROM memory or SDRAM memory may be used.

Each MDS node, similar in structure to the one depicted in FIG. 3 will be capable of receiving content from the Gigabit Ethernet adaptor for at least one stream, decoding it into usable multimedia content and providing that content to a display and/or speakers. Each MDS nod will also be capable of receiving any number of additional streams and providing that stream to at least one other MDS node in the hierarchy. These nodes, in conjunction with the Ethernet network provide substantial cost and setup ease savings over the use of traditional networks of baseband audio and video feeds.

It will be apparent to those skilled in the art that the disclosed inventions may be modified in numerous ways and may assume many embodiments other than the preferred forms specifically set out and described herein. For example, an integrated IEEE 802.3ah compliant Ethernet Passive Optical Network (EPON) Optical Networking Unit (ONU) could be substituted for the integrated Gigabit Ethernet processor and either a single IEEE 1000BASE-PX10 or IEEE 1000BASE-PX20 PHY could replace the 2 or more IEEE 802.3ab or ANSI/TIA 854 compliant PHYs.

Accordingly, it is intended by the appended claims to cover all modifications, which fall within the true spirit and scope of the present invention.

What is claimed is:

1. A method for distributing multimedia content streams to one or more video display devices comprising:
receiving a multimedia content stream on a first multimedia distribution switch node;
decoding the multimedia content stream;
providing the decoded multimedia content stream for display on a video display system; and
forwarding the first multimedia content stream to a second multimedia distribution switch node.

2. The method of claim 1 wherein at least one of said decoded multimedia content streams is baseband video content delivered to a video display device.

3. The method of claim 1 wherein said multimedia content stream is comprised of compressed video.

4. The method of claim 1 wherein said multimedia content stream is comprised of compressed audio.

5. The method of claim 1 wherein said multimedia content stream is encrypted.

6. The method of claim 1 wherein said decoded multimedia content stream is baseband video output in the form of as at least one of:
Component Video,
RGB Video,
Digital Visual Interface,
S-Video
High Definition Multimedia Interface,
Serial Digital Interface video, or
High Definition Serial Digital Interface video.

7. The method of claim 1 wherein said decoded multimedia content stream is baseband audio output in the form of at least one of:
stereo unbalanced analog audio,
Sony-Philips Digital Interface Format,
High Definition Multimedia Interface,
stereo balanced analog audio,
AES/EBU digital audio, or
Multimedia Digital Audio Interface.

8. The method of claim 1 wherein said multimedia content stream is received by said first multimedia distribution switch node through the use of a distributed network.

9. The method of claim 8 wherein said distributed network includes a Gigabit Ethernet switch.

10. The method of claim 1 wherein the multimedia content stream is receiving step is accomplished using Internet Protocol Multi-cast streams conforming to Internet Group Management Protocol Version 1.

11. The method of claim 1 wherein said multimedia distribution switch node decodes said multimedia content stream using a multimedia processor with a PCI bus interface capable of decoding compressed video.

12. The method of claim 11 wherein said multimedia processor has the capability to decode multimedia streams containing video encoded at a plurality of resolutions and to provide decoded multimedia content streams at a plurality of resolutions.

13. The method of claim 1 wherein said providing step further comprises output of said decoded multimedia content stream to a video display device integrated into the embodiment of the multimedia distribution switch node.

14. The method of claim 1 wherein said providing step further comprises output of said decoded multimedia content stream to a multimedia distribution switch node slot-card specific to a particular variety of video display.

15. The method of claim 1 wherein said providing step further comprises output of said decoded multimedia content stream to a video display device in which a multimedia distribution switch node is integrated.

16. The method of claim 1 wherein said providing step further comprises output of said decoded multimedia content stream from a stand-alone multimedia distribution switch box to a separate video display device.

17. The method of claim 14 wherein said multimedia distribution switch node slot-card conforms to the same physical, electrical, mechanical and safety regulatory requirements as the video display in which it is hosted.

18. The method of claim 15 wherein said multimedia distribution switch node feature module conforms to the same physical, electrical, mechanical and safety regulatory requirements as the video display in which it is hosted.

19. The method of claim 16 wherein said stand alone multimedia distribution switch node box can output baseband video to a separate video display in the form of at least one of:
Component Video,
RGB Video,
Digital Visual Interface,
S-Video
High Definition Multimedia Interface,
Serial Digital Interface video, or
High Definition Serial Digital Interface video.

20. The method of claim 16 wherein said stand alone multimedia distribution switch node box can output baseband audio to a separate video display in the form of at least one of:
stereo unbalanced analog audio,
Sony-Philips Digital Interface Format,
High Definition Multimedia Interface,
stereo balanced analog audio,
AES/EBU digital audio, or
Multimedia Digital Audio Interface.

21. The method of claim 1 wherein one of said second multimedia distribution switch nodes performs each of the steps of the method of claim 1.

22. A method for distributing multimedia content streams to one or more video display devices comprising:
receiving a multimedia content stream on a first multimedia distribution switch node;
decoding the multimedia content stream;
providing the decoded multimedia content stream for display on a video display system; and
forwarding the first multimedia content stream to a second multimedia distribution switch node, wherein the second multimedia distribution switch node performs each of the steps of the first multimedia distribution switch node.

23. An apparatus for distributing multimedia content streams to one or more video display devices comprising:
a reception means for receiving a multimedia content stream on a first multimedia distribution switch node;
a decoding means for decoding the multimedia content stream;
a multimedia output means for providing the decoded multimedia content stream for display on a video display system; and
a data output means forwarding the first multimedia content stream to a second multimedia distribution switch node.

24. The apparatus of claim 22 wherein at least one of said decoded multimedia content streams is baseband video content delivered to a video display device.

25. The apparatus of claim 22 wherein said multimedia content stream is comprised of compressed video.

26. The apparatus of claim 22 wherein said multimedia content stream is comprised of compressed audio.

27. The apparatus of claim 22 wherein said multimedia content stream is encrypted.

28. The apparatus of claim 22 wherein said decoded multimedia content stream is baseband video output in the form of as at least one of:
Component Video,
RGB Video,
Digital Visual Interface,
S-Video
High Definition Multimedia Interface,
Serial Digital Interface video, or
High Definition Serial Digital Interface video.

29. The apparatus of claim 22 wherein said decoded multimedia content stream is baseband audio output in the form of at least one of:
stereo unbalanced analog audio,
Sony-Philips Digital Interface Format,
High Definition Multimedia Interface,
stereo balanced analog audio,
AES/EBU digital audio, or
Multimedia Digital Audio Interface.

30. The apparatus of claim 22 wherein said multimedia content stream is received by said first multimedia distribution switch node through the use of a distributed network.

31. The apparatus of claim 29 wherein said distributed network includes a Gigabit Ethernet switch.

32. The apparatus of claim 22 wherein the multimedia content stream is transported to said reception means using Internet Protocol Multi-cast streams conforming to Internet Group Management Protocol Version 1.

33. The apparatus of claim 22 wherein said multimedia distribution switch node decodes said multimedia content stream using a multimedia processor with a PCI bus interface capable of decoding compressed video.

34. The apparatus of claim 32 wherein said multimedia processor has the capability to decode multimedia streams containing video encoded at a plurality of resolutions and to provide decoded multimedia content streams at a plurality of resolutions.

35. The apparatus of claim 22 wherein said multimedia output means further comprises the capability to output said decoded multimedia content stream to a video display device integrated into the embodiment of the multimedia distribution switch node.

36. The apparatus of claim 22 wherein said multimedia output means further comprises the capability to output said decoded multimedia content stream to a multimedia distribution switch node slot-card specific to a particular variety of video display.

37. The apparatus of claim 22 wherein said multimedia output means further comprises the capability to output said decoded multimedia content stream to a video display device in which a multimedia distribution switch node is integrated.

38. The apparatus of claim 22 wherein said multimedia output means further comprises the capability to output said decoded multimedia content stream from a stand-alone multimedia distribution switch box to a separate video display device.

39. The apparatus of claim 35 wherein said multimedia distribution switch node slot-card conforms to the same physical, electrical, mechanical and safety regulatory requirements as the video display in which it is hosted.

40. The apparatus of claim 36 wherein said multimedia distribution switch node feature module conforms to the same physical, electrical, mechanical and safety regulatory requirements as the video display in which it is hosted.

41. The apparatus of claim 37 wherein said stand alone multimedia distribution switch node box can output baseband video to a separate video display in the form of at least one of:
Component Video,
RGB Video,
Digital Visual Interface,
S-Video
High Definition Multimedia Interface,
Serial Digital Interface video, or
High Definition Serial Digital Interface video.

42. The apparatus of claim 37 wherein said stand alone multimedia distribution switch node box can output baseband audio to a separate video display in the form of at least one of:
stereo unbalanced analog audio,
Sony-Philips Digital Interface Format,
High Definition Multimedia Interface,
stereo balanced analog audio,
AES/EBU digital audio, or
Multimedia Digital Audio Interface.

43. The apparatus of claim 37 wherein one of said second multimedia distribution switch nodes is comprised of each of the elements of the apparatus described in claim 1.

44. An apparatus for distributing multimedia content streams to one or more video display devices comprising:
a first multimedia distribution switch node including:
1. a reception means for receiving a multimedia content stream on a first multimedia distribution switch node;
2. a decoding means for decoding the multimedia content stream;
3. a multimedia output means for providing the decoded multimedia content stream for display on a video display system; and
4. a data output means forwarding the first multimedia content stream to a second multimedia distribution switch node; and
at least a second multimedia distribution switch node containing each of the elements of the first multimedia distribution switch node.
